(19) United States
(12) Patent Application Publication
(10) Pub. No.: US 2010/0214574 A1
(43) Pub. Date: Aug. 26, 2010

(54) COPYING APPARATUS, CONTROL METHOD THEREFOR, AND PROGRAM

(75) Inventor: Tetsuya Tamaki, Sapporo-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Tokyo (JP)

(21) Appl. No.: 12/711,875

(22) Filed: Feb. 24, 2010

(30) Foreign Application Priority Data
Feb. 26, 2009 (JP) 2009-043558

(51) Int. Cl. G06K 15/02

(52) U.S. Cl. 358/1.2

(57) ABSTRACT

A copying apparatus for copying an image of an original document on a recording paper, the copying apparatus includes: a reading section that transports paper, which is an original document or recording paper and is placed on a paper placing section capable of containing the paper, and reads a size and an image of the paper; a printing section that performs printing on the paper and discharges the paper; a switching transport section that switches transporting of the paper, of which the image is read by the reading section, to the printing section side and discharging of the paper.

### BACKGROUND

1. Technical Field

The present invention relates to a copying apparatus, a control method therefor, and a program therefor.

2. Related Art

Generally, there has been proposed a copying apparatus in which a recording paper transport path is provided in connection with an original document transport path of a scanner and the original document transport path and the recording paper transport path are switched by the turning of branch flaps (for example, refer to JP-A-6-303397). Such an apparatus is operated as follows. When a copy mode is designated, an image of a recording paper or an original document fed from a paper feeding base is read by an image sensor. In this case, when the image is detected while the leading end of the original document or the recording paper reaches the branch flap, it is determined that the transported paper is an original document, and the branch flap is held at a position for closing the recording paper transport path, thereby discharging the original document to the paper discharging tray. In contrast, when the image is not detected while the leading end of the original document or the recording paper reaches the branch flap, it is determined that the transported paper is a recording paper, and the branch flap is turned to a position for opening the recording paper transport path, thereby transporting the recording paper to the paper feeding unit through the paper feeding transport path.

In such a copying apparatus, when the sizes of the original document and the recording paper placed on a platen are different from each other, it is necessary for a user to set an enlargement ratio or a reduction ratio. For this reason, there is demand for the ability to easily copy the image of the original document on the recording paper even when the sizes of the original document and the recording paper placed on the platen are different from each other.

### SUMMARY

An advantage of some aspects of the invention is that it provides a copying apparatus, a control method, and a program capable of easily copying the image of the original document on the recording paper even when the sizes of the original document and the recording paper placed on the platen section are different from each other.

In order to achieve the principal advantage, the copying apparatus, the control method, and the program according to the aspects of the invention employ the following means.

According to an aspect of the invention, a copying apparatus for copying an image of an original document on a recording paper, the copying apparatus includes: a reading section that transports paper, which is an original document or recording paper and is placed on a paper placing section capable of containing the paper, and reads a size and an image of the paper; a printing section that performs printing on the paper and discharges the paper; a switching transport section that switches transporting of the paper, whose image is read by the reading section, to the printing section side and discharging of the paper; a storage section that stores data; and a control section that executes a reading process for controlling the reading section to read an image of the paper and a size thereof by transporting the paper, which is placed on the paper placing section, and determines whether the read paper which is subjected to the reading process is an original document or recording paper. When it is determined that the read paper is an original document, the control section controls the switching transport section to discharge the original document, and stores the size and the image of the original document, which is read by the reading process, in the storage section. In contrast, when it is determined that the read paper is recording paper, the control section controls the switching transport section to transport the recording paper to the printing section, and controls the printing section to perform printing on the recording paper and discharge the recording paper on the basis of adjustment between the size of the recording paper and the size of the stored image, which is based on the original document size stored in the storage section, stored in the storage section.

In the copying apparatus according to the aspect of the invention, the reading process for controlling the reading section to read an image of the paper and a size thereof by transporting the paper, which is placed on the paper as the original document or the recording paper placing section capable of containing the paper, is executed, and it is determined whether the read paper which is subjected to the reading process is an original document or recording paper. When it is determined that the read paper is an original document, the switching transport section is controlled to discharge the original document, and the size and the image of the original document, which is read by the reading process, are stored in the storage section. In contrast, when it is determined that the read paper is recording paper, the switching transport section is controlled to transport the recording paper to the printing section, and the printing section is controlled to perform printing on the recording paper and discharge the recording paper on the basis of adjustment between the size of the recording paper and the size of the stored image, which is based on the original document size stored in the storage section, stored in the storage section. With such a configuration, when instructing the copying of the image of the original document on the recording paper in a state where the original document and the recording paper are placed on the paper placing section, it is possible to easily copy the image of the original document on the recording paper even when the sizes of the original document and the recording paper are different from each other.

In the copying apparatus according to the aspect of the invention, it is preferable that the switching transport section be operable to transport the paper to the printing section so that a surface, of which the image is read by the reading section, of both surfaces of the paper is the same as a surface, which is printed by the printing section, of both surfaces of the paper. In this case, when the recording paper is transported to the printing section, the switching transport section is controlled to transport the recording paper to the printing section so that the surface, of which the image is read by the reading section, of both surfaces of the paper (the original document or the recording paper) is the same as the surface, which is printed by the printing section, of both surfaces of the recording paper. With such a configuration, a user has only to place the original document and the recording paper on the paper placing section in this order so that the surface, of which the image is read by the reading section, of both surfaces of the original document is the same as the surface, which is printed by the printing section, of both surfaces of the recording paper (for example, the same lower surface). As a result, it is possible to make the operation easier for the user when copying the image of the original document on the recording paper.

Further, in the copying apparatus according to the aspect of the invention, it is preferable that the switching transport section be operable to transport the paper to the printing section so that the leading end of the paper is the same when the paper, which is placed on the paper placing section, is transported by the reading section and when the paper is transported to the printing section. In this case, when the recording paper is transported to the printing section, the switching transport section is controlled to transport the recording paper to the printing section so that the leading end of the paper is the same when the paper (the original document or the recording paper), which is placed on the paper placing section, is transported by the reading section and when the recording paper is transported to the printing section. Thereby, it is possible to copy the image of the original document on the recording paper while maintaining the direction (the transport direction) of the original document and the recording paper which are placed on the paper placing section.

In the copying apparatus according to the aspect of the invention, it is preferable that the switching transport section be operable to transport the paper, on which the image reading is performed by the reading section, to a second paper placing section on the printing section side, and be operable to transport the paper on the second paper placing section to the printing section. In addition, it is also preferable that, when it is determined that the read paper is the recording paper, the control section should control the switching transport section to transport the recording paper to the second paper placing section, and control the switching transport section to transport the recording paper, which is transported to the second paper placing section, to the printing section. In such a manner, it is possible to make the printing section perform the printing on the recording paper which is transported in the order of the second paper placing section and printing section. In the copying apparatus according to this aspect of the invention, it is preferable that, after it is determined whether each of all the papers placed on the paper placing section is an original document or recording paper, the control section should control the switching transport section to transport the recording paper, which is transported to the second paper placing section, to the printing section. In this case, until it is determined whether each of all the papers placed on the paper placing section is an original document or recording paper, the printing is not performed on the recording paper. Hence, it is possible to perform more promptly the discrimination between the original document and the recording paper on all the papers placed on the paper placing section as compared with the case where the completion of the printing of the previous recording paper is awaited and the reading process is performed on the next paper.

Alternatively, in the copying apparatus according to the aspect of the invention, it is preferable that, when it is determined that the read paper is recording paper, the control section should control the printing section to perform the printing on the recording paper and discharge the paper on the basis of the adjustment of the size of the stored image based on how many times the printing is performed on the recording paper before the current time. Further, it is also preferable that, when it is determined that the read paper is an original document, the control section should replace the image of the original document, which is read by the reading process, with the image, which is read by the reading process, of the original document previous to the recording paper previous to the current time, and should store the image in the storage section.

In the copying apparatus according to the aspect of the invention, it is preferable that the switching transport section be operable to transport the recording paper to the printing section by switching back the surface of the recording paper, of which the first surface is printed by the printing section, so that the printing section is able to perform the printing on the second surface of the recording paper. In addition, it is also preferable that the control section should control the printing section to perform the printing on the first surface of the recording paper when both surfaces of the recording paper are printed, should control the switching transport section to transport the recording paper to the printing section by switching back the surface of the recording paper after the printing is performed on the first surface, and should control the printing section to perform the printing on the second surface of the transported recording paper. In such a manner, it is possible to perform the printing on both surfaces of the recording paper.

In the copying apparatus according to the aspect of the invention, it is preferable that the switching transport section be operable to transport the paper to the reading section by switching back the surface of the paper, of which the image of the first surface is read by the reading section, so that the reading section is able to read the second surface of the paper. In addition, it is also preferable that the control section should control the reading section to read the first surface of the paper when the images of both surfaces of the paper are read by the reading process, should control the switching transport section to transport the paper to the reading section by switching back the surface of the paper after the image of the first surface is read, and should control the reading section to read the image of the second surface of the transported paper. Further, in the copying apparatus according to the aspect of the invention, it is preferable that the reading section should include a first reading section for reading the size and the image of the first surface of the paper and a second reading section for reading the image of the second surface of the paper. In these cases, it is possible to read the images of both surfaces of the original document, and it is also possible to print the images of both surfaces on the recording paper.

According to another aspect of the invention, a control method of a copying apparatus includes: a reading section that transports paper, which is an original document or recording paper and is placed on a paper placing section capable of containing the paper, and reads a size and an image of the paper; a printing section that performs printing on the paper and discharges the paper; a switching transport section that switches transporting of the paper, of which the image is read by the reading section, to the printing section side and discharging of the paper; and a storage section that stores data. The control method includes: executing a reading process for controlling the reading section to read an image of the paper and a size thereof by transporting the paper, which is placed on the paper placing section, determining whether the read paper which is subjected to the reading process is an original document or recording paper; controlling the switching transport section to discharge the original document, and storing the size and the image of the original document, which is read by the reading process, in the storage section when determining that the read paper is the original document; and controlling the switching transport section to transport the recording paper to the printing section, and controlling the printing section to perform printing on the recording paper and discharge the recording paper on the basis of adjustment between the size of the recording paper and the size of the stored image, which is based on the original document size stored in the storage section, stored in the storage section when determining that the read paper is the recording paper.

In the control method of the copying apparatus according to the aspect of the invention, the reading process for controlling the reading section to read an image of the paper and a size thereof by transporting the paper, which is placed on the paper as the original document or the recording paper placing section capable of containing the paper, and it is determined whether the read paper which is subjected to the reading process is an original document or recording paper. When it is determined that the read paper is an original document, the switching transport section is controlled to discharge the original document, and the size and the image of the original document, which are read by the reading process, are stored in the storage section. In contrast, when it is determined that the read paper is the recording paper, the switching transport section is controlled to transport the recording paper to the printing section, and the printing section is controlled to perform printing on the recording paper and discharge the recording paper on the basis of adjustment between the size of the recording paper and the size of the stored image, which is based on the original document size stored in the storage section, stored in the storage section. With such a configuration, when instructing the copying of the image of the original document on the recording paper in a state where the original document and the recording paper are placed on the paper placing section, it is possible to easily copy the image of the original document on the recording paper even when the sizes of the original document and the recording paper are different from each other.

According to a further aspect of the invention, there is a program for causing one or more computers to execute the steps of the control method of the copying apparatus. The program may be recorded in a computer-readable recording medium (for example, a hard disk, a ROM, an FD, a CD, a DVD, and the like), may be transferred from a computer linked with a transmission medium (a communication network such as internet or LAN) to other computers, and may be exchanged in any other forms. When the program is executed in one computer or is executed by assigning the steps thereof to a plurality of computers, the steps of the control method of the copying apparatus according to the aspect of the invention are executed. Hence, it is possible to obtain the same advantages as the control method of the copying apparatus according to the aspect of the invention.

### BRIEF DESCRIPTION OF THE DRAWINGS

The invention will be described with reference to the accompanying drawings, wherein like numbers reference like elements.

FIG. 1 is a configuration diagram illustrating a schematic configuration of a multi-function peripheral.

FIG. 2 is a configuration diagram illustrating a schematic configuration of the multi-function peripheral.

FIG. 3 is a flowchart illustrating an example of a superposition copy process routine.

FIG. 4 is an explanatory diagram illustrating an example of original documents and recording papers.

FIG. 5 is an explanatory diagram illustrating an example of a table of a relationship between image data and sizes of papers.

FIG. 6 is an explanatory diagram illustrating an example of the original documents and the recording papers.

FIG. 7 is a flowchart illustrating an example of the superposition copy process routine.

FIG. 8 is a flowchart illustrating an example of the superposition copy process routine.

FIG. 9 is an explanatory diagram illustrating an example of the transportation of the recording papers.

FIG. 10 is an explanatory diagram illustrating an example of the transportation of the papers.

### DESCRIPTION OF EXEMPLARY EMBODIMENTS

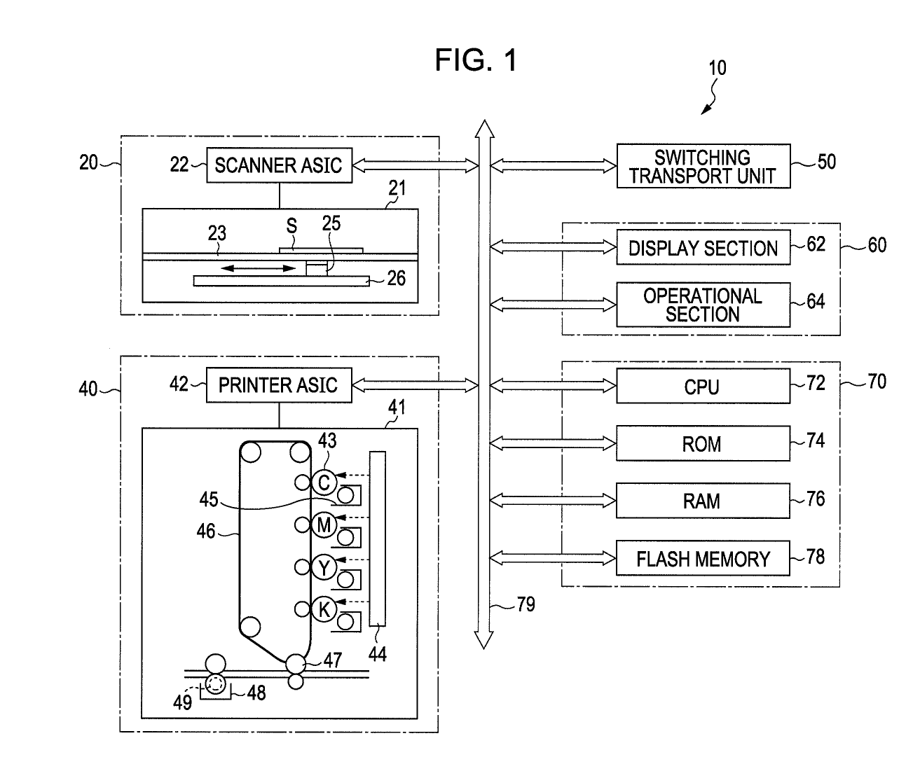

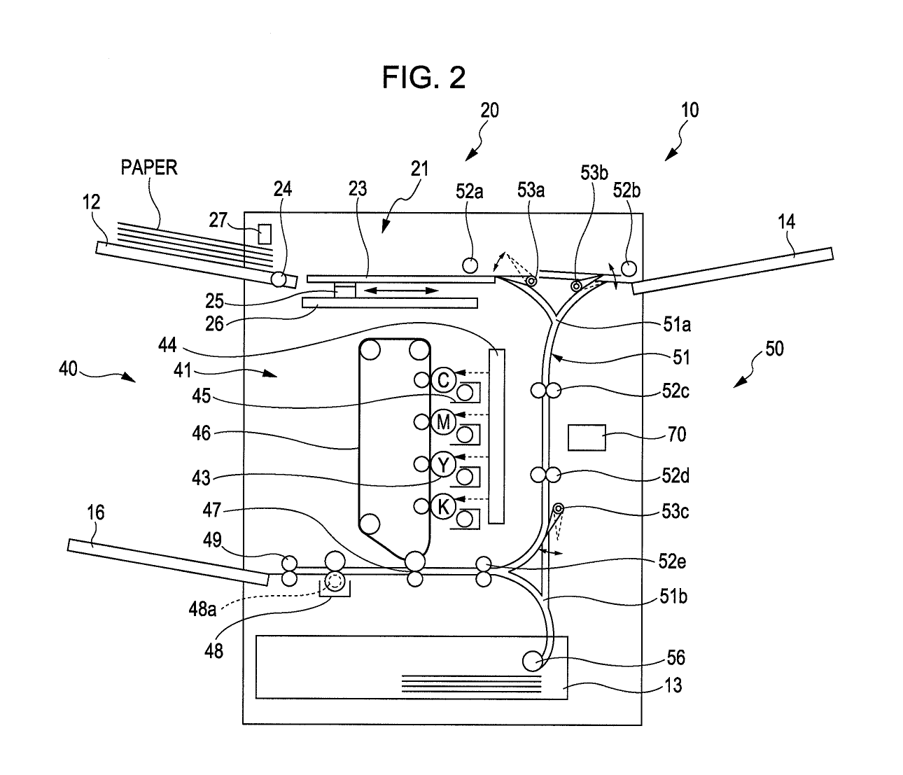

Hereinafter, embodiments of the invention will be described with reference to the accompanying drawings. FIGS. 1 and 2 are configuration diagrams illustrating schematic configurations of a multi-function peripheral 10 according to an embodiment of the invention. As shown in FIGS. 1 and 2, the multi-function peripheral 10 of the embodiment includes: a scanner section 20 that is disposed in the upper part of the multi-function peripheral 10 in the middle (refer to FIG. 2) thereof so as to transport paper S (an original document or recording paper), which is placed on a paper tray 12, and read an image of the paper S; a paper discharging tray 14 that is disposed on the right side of FIG. 2 viewed from the scanner section 20; a printer section 40 that is disposed below the scanner section 20 so as to print the paper S and discharge the paper to the paper discharging tray 16; a paper cassette 13 that is disposed below the printer section 40 so as to be able to contain the paper S; a switching transport unit 50 that transports the paper S along a transport path 51 which connects the scanner section 20, the paper discharging tray 14, the printer section 40, and the paper cassette 13; an operational panel 60 that allows a user to input various instructions; and a controller 70 that is in charge of entire system control.

The scanner section 20 includes a scanner engine 21 and a scanner ASIC 22. The scanner engine 21 includes: a transport roller 24 that transports the paper S, which is placed on the bottom of the paper tray 12, to a reading section 23; a line image sensor 25 that optically reads the lower surface of the paper S transported to the reading section 23; a movable section 26 that makes the line image sensor 25 perform scanning; and a paper sensor 27 that detects whether or not the paper exists in the paper tray 12. Here, the line image sensor 25 is configured as a known color image sensor that separates the reflection light emitted toward the paper S into red (R), green (G), and blue (B) colors, and converts those into scan data. The scanner ASIC 22 is an IC chip that has a function for controlling the scanner engine 21 and stores the scan data, which is read by the line image sensor 25, in a RAM 76 of the controller 70. Furthermore, “ASIC” is an abbreviation of Application Specific Integrated Circuit.

The printer section 40 includes a printer engine 41 and a printer ASIC 42. The printer engine 41 is configured as a full-color-electrophotographic-type printer engine that employs a tandem-type intermediate transfer system. The printer engine includes: photoconductors 43C, 43M, 43Y, and 43K (hereinafter, those are collectively referred to as photoconductors 43) that are provided for the respective colors of cyan (C), magenta (M), yellow (Y), black (K); an exposure unit 44 that forms images of the respective colors as electrostatic latent images by irradiating laser light onto the photoconductors 43 of the colors; a development unit 45 that develops the formed electrostatic latent images for the respective colors; an intermediate transfer belt 46 onto which the developed toner images are transferred for the respective colors; a secondary transfer unit 47 that transfers the full-color toner image, which is formed on the intermediate transfer belt 46, to paper; a fixing unit 48 that fixes the full-color toner image transferred to the paper; and a paper discharging roller 49 that discharges the paper S to the paper discharging tray 16. The printer ASIC 42 is an IC chip having a function for controlling the printer engines 41. The printer ASIC develops the data, which is stored in the RAM 76 of the controller 70, into a bitmap image for each page, and controls the printer engine 41 to print the data on the recording paper.

The switching transport unit 50 includes: a transport roller 52a that transports the paper S between the transport path 51 and the scanner section 20; a transport roller 52b that transports the paper S between the transport path 51 and the paper discharging tray 14; transport rollers 52c to 52e that transport the paper S along the transport path 51; a transport roller 56 that transports the recording paper, which is placed on the top of the paper cassette 13, to the transport path 51; a switching member 53a that switches a transport destination of the paper S, which is sent from the scanner section 20, between the paper discharging tray 14 side and the printer section 40 (or the paper cassette 13) side and enables transport of the paper S from the paper discharging tray 14 side to the scanner section 20 side; a switching member 53b that switches a transport destination of the paper S, which is sent from the paper discharging tray 14, between the scanner section 20 side and the printer section 40 side and enables transport of the paper S from the scanner section 20 side and the printer section 40 to the paper discharging tray 14 side; a switching member 53c that switches a transport destination of the paper S, which is sent from the scanner section 20 (or the paper discharging tray 14), between the printer section 40 side and the paper cassette 13 side and enables transport of the paper S from the printer section 40 to the paper discharging tray 14 side. Here, the transport rollers 52a to 52e (hereinafter, those are collectively referred to as transport rollers 52) and 56 are configured to rotate by driving motors, which are not shown in the drawing, on the basis of the signals from the controller 70. In addition, the switching members 53a to 53c (hereinafter, collectively referred to as switching members 53) are configured to be turned by driving motors, which are not shown in the drawings, on the basis of the signals from the controller 70. Further, in the embodiment, the transport path 51 is formed as follows: At a three-way junction 51 a connecting the scanner section 20 side, the paper discharging tray 14 side, and the printer section 40 (or paper cassette 13), the paper S sent from the scanner section 20 side is transported to the printer section 40 side, the paper S sent from the printer section 40 side is transported to the paper discharging tray 14 side, and the paper S sent from the paper discharging tray 14 is transported to the printer section 40 side. At a three-way junction 51b connecting the scanner section 20 (or the paper discharging tray 14) side, the printer section 40 side, and the paper cassette 13 side, the paper S sent from the scanner section 20 side is transported to the paper cassette 13 side, and the paper S sent from the paper cassette 13 side is transported to the printer section 40 side. In the transport path 51, the paper S may be transported from the scanner section 20 to the printer section 40 without passing through the paper discharging tray 14 or the paper cassette 13. In this case, in both surfaces of the paper S, the surface (the readout surface), on which an image is read by the scanner section 20, is the same as the surface (the printed surface) on which the printing is performed by the printer section 40. In addition, the paper S of the paper tray 12 on the scanner section 20 side becomes the same as the leading end of the paper S transported to the printer section 40 side. Further, in the transport path 51, the paper S may be transported from the paper cassette 13 to the printer section 40. In this case, the lower surface of the paper S of the paper cassette 13 is the same as the printed surface thereof. In addition, the paper S of the paper cassette 13 on the transport path 51 becomes the same as the leading end of the paper S transported to the printer section 40.

The operational panel 60 is a device that assists a user to input various instructions to the multi-function peripheral 10, and is provided with a display section 62 that is constituted by a color liquid crystal panel for displaying letters and images based on the various instructions and an operational section 64 by which various operations are performed.

The controller 70 is configured as a micro processor based on a CPU 72, and includes a ROM 74 that stores various process programs, a RAM 76 that temporarily stores data, and a flash memory 78 that is able to record and delete the data. The controller 70 is electrically connected via a bus 79 to the scanner ASIC 22, the switching transport unit 50, the printer ASIC 42, and the operational panel 60. The controller is configured to output: readout control signals to the scanner ASIC 22; drive signals to the motors, which are not shown in the drawing, for driving the transport rollers 52 and 56 of the switching transport unit 50 and the switching members 53; print command signals to the printer ASIC 42; and display command signals to the operational panel 60. In addition, the controller is configured to input: signals as to a state of the scanner section 20 from the scanner ASIC 22; signals as to a state of the printer section 40 from the printer ASIC 42; and various command signals from the operational panel 60.

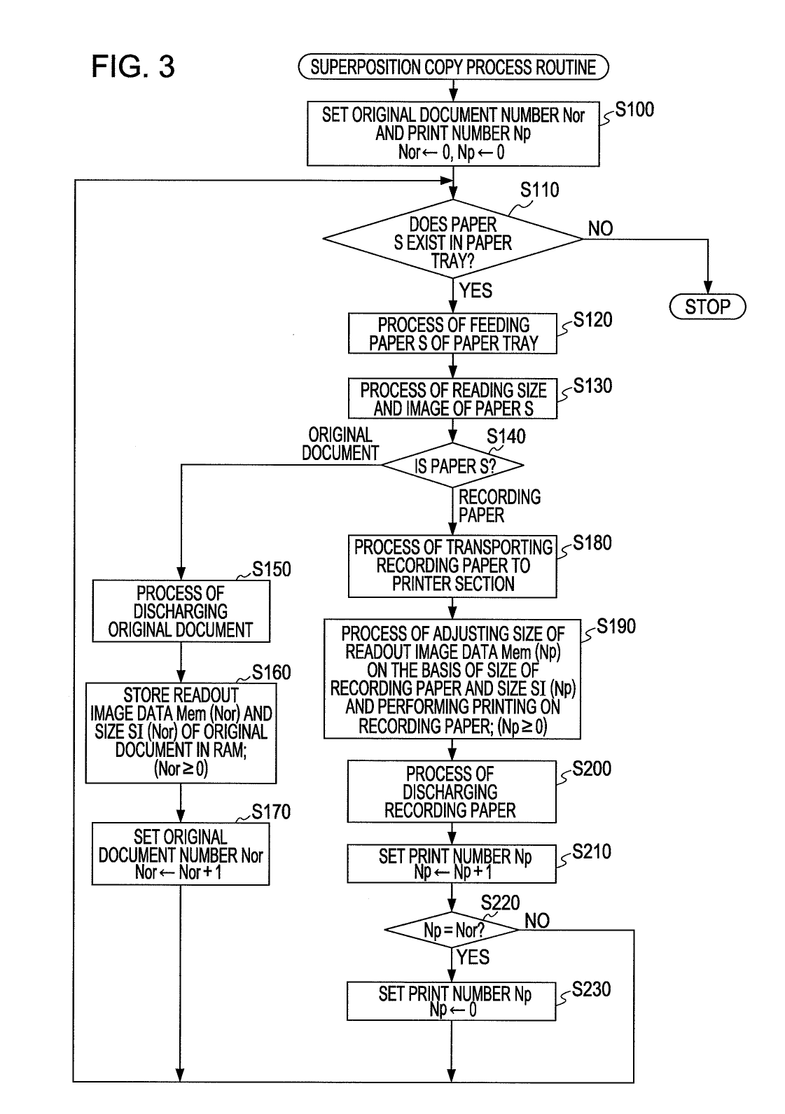

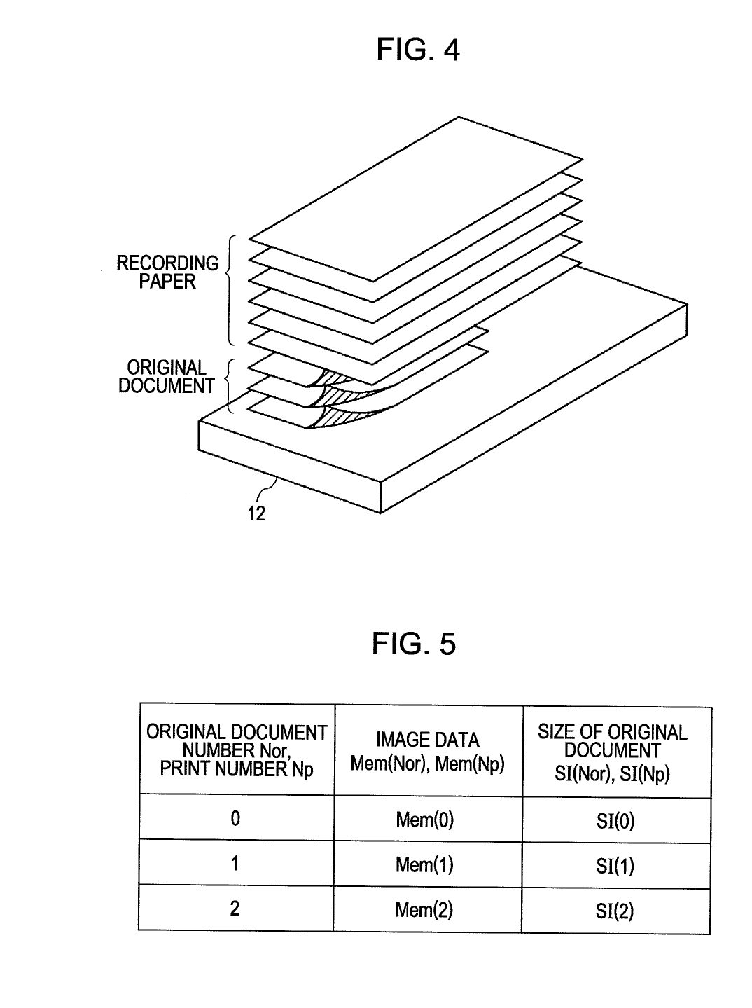

Next, operations of the multi-function peripheral 10 according to the embodiment configured in this manner will be described. In particular, the operations for executing a superposition copy process of copying images of original documents placed on the paper tray 12 on recording papers similarly placed on the same paper tray 12 will be described. FIG. 3 is a flowchart illustrating an example of a superposition copy process routine executed by the CPU 72 of the controller 70. The routine is stored in the ROM 74, and is executed when a user instructs execution of the superposition copy process. Furthermore, in the embodiment, as exemplified in FIG. 4, the following case is described: three sheets of the original document, which have images on the lower surfaces (the hatched surfaces shown in FIG. 4) thereof when placed on the paper tray 12, and six sheets of the recording paper, of which the size is different from that of the original documents, are placed on the paper tray 12 in order (in the order that the scanner section 20 performs the reading process to be described later) from the bottom, and in this state, the copying of the images of the original documents on the recording papers is instructed. In this case, a user places the three sheets of the original document and the six sheets of the recording paper on the paper tray 12 in the order of the three sheets of the original document and the six sheets of the recording paper from the bottom so that the respective lower surfaces are set to be the above-mentioned readout surfaces, and selects the superposition copy process and instructs the execution of the process by operating the operational section 64 of the operational panel 60. Hereinafter, for convenience of description, when the paper S (the original document or the recording paper) is placed on the paper tray 12, the lower surface thereof is referred to as a placed-state lower surface (the same as the above-mentioned readout surface), the upper surface thereof is referred to as a placed-state upper surface, the scanner section 20 side thereof is referred to as a placed-state leading end side, and the side opposite to the placed-state leading end side is referred to as a placed-state tailing end side.

When the superposition copy process routine is executed, first the CPU 72 of the controller 70 sets values of an original document number Nor and a print number Np to 0 (step S100). Then, on the basis of the signals which are input through the scanner ASIC 22 by the detection of the paper sensor 27, the CPU 72 determines whether the paper S (the original document or the recording paper) exists on the paper tray 12 (step S110). If it is determined that the paper S exists on the paper tray 12, the paper feeding process for driving the transport roller 24 is performed by the scanner ASIC 22 so as to transport the paper S on the bottom of the paper tray 12 onto the reading section 23 on the placed-state leading end side (step S120). Then, the reading process for controlling the line image sensor 25 is performed by the scanner ASIC 22 so as to read the size and the image of the placed-state lower surface of the paper S which is transported onto the reading section 23 (step S130). Here, the process of the step S110 is a process for determining whether each of all the papers S placed on the paper tray 12 is an original document or recording paper.

In such a manner, when the scanner section 20 performs the reading process, on the basis of the result of the reading process, it is determined whether the paper S is recording paper or an original document (whether or not the paper S is blank paper) (step S140). If it is determined that the paper S is an original document, the paper discharging process for driving the transport rollers 52 and the switching members 53 of the switching transport unit 50 is performed to discharge the original document to the paper discharging tray 14 (step S150). Then, the image, which is read by the reading process in the scanner section 20, is converted into image data Mem (Nor), and the scanner ASIC 22 stores the size of the original document as a size SI (Nor) in the RAM 76 (step S160). By adding a value of 1 to the original document number Nor, the original document number Nor is updated (step S170), and the routine returns to the process of step S110. Here, the image data Mem (Nor) and the size SI (Nor) are used as image data Mem (Np) and a size SI (Np) when the printing is performed on the recording paper, and “Nor” and “Np” in the image data Mem (Nor) and Mem (Np) and the sizes SI (Nor) and SI (Np) are integers equal to or more than a value of 0. In the embodiment, considering the case where the three sheets of the original document and the six sheets of the recording paper are placed on the paper tray 12 in order from the bottom, the process of step S120 to S170 is repeatedly executed, thereby storing image data Mem (0), Mem (1), and Mem (2) and sizes SI (0), SI (1), and SI (2) of the three sheets of the original document in the RAM 76 as exemplified in FIG. 5. Further, for the purpose of reference, FIG. 5 also shows the original document number Nor and the print number Np corresponding to the image data Mem (Nor).

In step S140, if it is determined that the paper S is the recording paper, the recording paper is transported to the printer section 40 by driving the transport rollers 52 and the switching members 53 of the switching transport unit 50 such that the placed-state lower surface (the same as the readout surface) of the recording paper is the same as the printed surface thereof and the placed-state leading end of the recording paper is the same as the leading end of the recording paper transported to the printer section 40 (in the embodiment, the recording paper is transported without change from the scanner section 20 to the printer section 40 as shown in FIG. 2) (step S180). Then, the printing and discharging processes are performed in which the printer ASIC 42 controls the printer engine 41 to perform the printing on the placed-state lower surface of the recording paper, which is transported to the printer section 40, and to discharge the paper to the paper discharging tray 16, in accordance with the adjustment of the size of the image data Mem (Np) stored in the RAM 76 (step S190, S200). Here, in the embodiment, the adjustment of the size of the image data Mem (Np) is performed by adjusting the size of the image data Mem (Np) stored in the RAM 76 in accordance with a ratio of the size SI (Np), which is stored in the RAM 76, to the size of the paper S which is to be printed at the current time. In such a manner, for example, when B5 size original documents and A4 size recording papers are placed on the paper tray 12, images, of which a size is automatically enlarged from B5 to A4, can be printed on the recording papers. Accordingly, even when the original document papers and the recording papers having different sizes from each other are placed on the paper tray 12, it is not necessary for a user to perform a task for setting an enlargement ratio or a reduction ratio. Hence, a user can easily copy the image of the original document, which is placed on the paper tray 12, on the recording paper which is placed on the paper tray 12 similarly. Moreover, when the paper S is recording paper, the recording paper is transported to the printer section 40 such that the placed-state lower surface (the same as the readout surface) of the recording paper is the same as the printed surface thereof and the placed-state leading end of the recording paper is the same as the leading end of the recording paper transported to the printer section 40. Hence, a user arranges the image-formed surfaces of the original documents and the print-target surfaces of the recording papers, arranges the scanner section 20 sides of the original documents and the scanner section 20 sides of the recording papers, and places the original documents and the recording papers on the paper tray 12, and in this state, the user has only to instruct the execution of the above-mentioned superposition copy process. Accordingly, it is possible to make the operation easier for the user when copying the images of the placed-state lower surfaces of the original documents on the placed-state lower surfaces of the recording papers.

Subsequently, by adding a value of 1 to the print number Np, the print number Np is updated (step S210). Then, it is determined whether or not the updated print number Np is equal to the original document number Nor (step S220). If the print number Np is smaller than the original document number Nor, the routine directly returns to the process of step S110. In contrast, if the print number Np is equal to the original document number Nor, the print number Np is set to a value of 0 (step S230), and the routine returns to the process of step S110. The process of steps S220 and S230 is a process for copying a set of first to Norset-th sheets of the original document on the recording papers part by part when the number of original document sheets Norset of the papers S placed on the paper tray 12 is larger than the number of recording paper sheets Npset (for example, three sheets of the original document and six sheets of the recording paper are placed and so on). In the embodiment, considering the case where the three sheets of the original document and the six sheets of the recording paper are placed on the paper tray 12 in order from the bottom, the sizes thereof are adjusted in the order of the image data Mem (0), Mem (1), Mem (2), Mem (0), . . . , and thereby the printing can be performed on the recording paper. Then, if it is determined in step S110 that there is no paper S in the paper tray 12, the routine is terminated.

Here, the correspondence relationship between the components according to the embodiment and the components according to the aspects of the invention is clarified. The scanner section 20 of the embodiment corresponds to the reading section, the printer section 40 corresponds to the printing section, the switching transport unit 50 corresponds to the switching transport section, the RAM 76 corresponds to the storage section, and the CPU 72, the scanner ASIC 22, and the printer ASIC 42 correspond to the control section. Furthermore, since the embodiment describes the operations of the multi-function peripheral 10, an example of the control method of the copying apparatus according to the aspects of the invention is also clarified.

The above-mentioned multi-function peripheral 10 according to the embodiment is operated as follows. When a user operates the operational panel 60 in a state where the plurality of papers S including the original documents and the recording papers are placed on the paper tray 12 so as to instruct the copying of the images of the original documents to the recording papers, the images and the sizes of the papers S are read. On the basis of the result of the reading, it is determined whether each paper S is the original document or the recording paper. If the paper S is the original document, the image data Mem (Nor) and the size SI (Nor) are stored in the RAM 76. In contrast, if the paper S is the recording paper, the size of the image data Mem (Np) stored in the RAM 76 is adjusted in accordance with the ratio of the size SI (Np), which is stored in the RAM 76, to the size of the recording paper which is to be printed at the current time, thereby performing the printing on the recording paper. As a result, it is possible to easily copy the image of the original document on the recording paper even when the sizes of the original document and the recording paper placed on the paper tray 12 are different from each other.

Further, the multi-function peripheral 10 according to the embodiment is operated as follows. When the paper S is the recording paper, the recording paper is transported to the printer section 40 such that the placed-state lower surface (the same as the readout surface) of the recording paper is the same as the printed surface thereof and the placed-state leading end of the recording paper is the same as the leading end of the recording paper transported to the printer section 40. Hence, a user arranges the image-formed surfaces of the original documents and the print-target surfaces of the recording papers, and arranges the scanner section 20 sides of the original documents and the scanner section 20 sides of the recording papers, and in this state, the user has only to instruct the execution of the above-mentioned superposition copy process. Accordingly, it is possible to make the operation easier for the user when copying the images of the placed-state lower surfaces of the original documents on the placed-state lower surface of the recording paper.

Furthermore, the invention is not limited to the above-mentioned embodiment, and it is needless to say that the invention may be modified into various forms without departing from the technical scope of the invention.

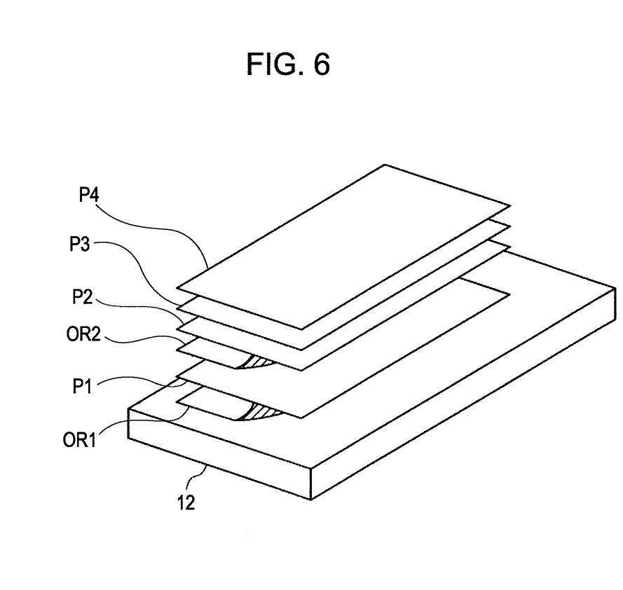

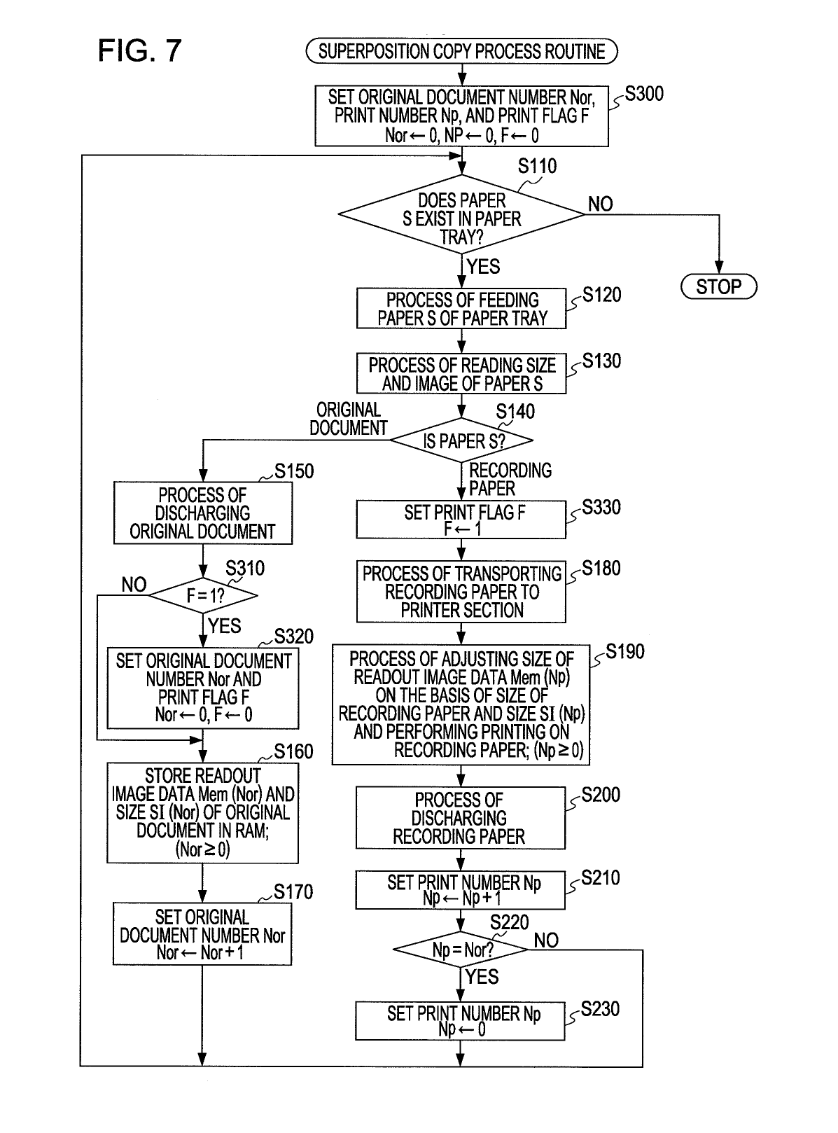

In the above-mentioned embodiment, as exemplified in FIG. 6, one sheet of original document OR1, of which the placed-state lower surface (the hatched surfaces shown in FIG. 6) has an image formed thereon, one sheet of the recording paper Pl, one sheet of the original document OR2, and three sheets of the recording papers P2 to P4 are placed on the paper tray 12 in order from the bottom. In this case, the image data Mem (0) of the original document OR1 is printed on the recording papers P1, P2, and P4, and the image data Mem (1) of the original document OR2 is printed on the recording paper P3. However, the image data of the original document OR1 may be printed on the recording paper Pl, and the image data of the original document OR2 may be printed on the recording papers P2 to P4. FIG. 7 shows an example of the superposition copy process routine in this case. The superposition copy process routine of FIG. 7 is the same as the superposition copy process routine of FIG. 3 except that the process of step S300 is executed instead of the process of step S100 and the processes of steps S310 to S330 are added. Accordingly, the same processes are referenced by the same step numbers, and detailed description thereof will be omitted. In the superposition copy process routine of FIG. 7, first, the CPU 72 of the controller 70 respectively sets the original document number Nor and the print number Np to values of 0, similarly to the process of step S100 in the superposition copy process routine of FIG. 3, and sets the print flag F, which represents whether or not the printing is performed on the recording paper, to a value of 0 (step S300). Then, if it is determined in step S140 that the paper S is the recording paper, the print flag F is set to a value of 1 (step S330), and the processes from step S180 are executed. In contrast, if it is determined in step 5140 that the paper S is the original document, the paper discharging process is performed on the original document (step S150), thereby adjusting the value of the print flag F (step S310). The process of step S310 is a process for determining whether or not the paper S subjected to the reading process is an original document immediately subsequent to the recording paper. If the print flag F is a value of 1, it is determined that the paper S is an original document immediately subsequent to the recording paper, and the original document number Nor is set to a value of 0, and the print flag F is set to a value of 0 (step S320), and the processes from step S160 are executed. In contrast, if the print flag F is a value of 0, it is determined that the paper S is not the original document immediately subsequent to the recording paper, and the process of step S410 is not executed, but the processes from step S160 are executed. In this case, in the example of FIG. 6, when the reading process is performed on the original document OR2, the image data Mem (0) is replaced from the image data of the original document OR1 to the image data of the original document OR2. As a result, it is possible to print the image data Mem (0) of the original document OR2 on the recording papers P2 to P4 subsequent to the original document OR2.

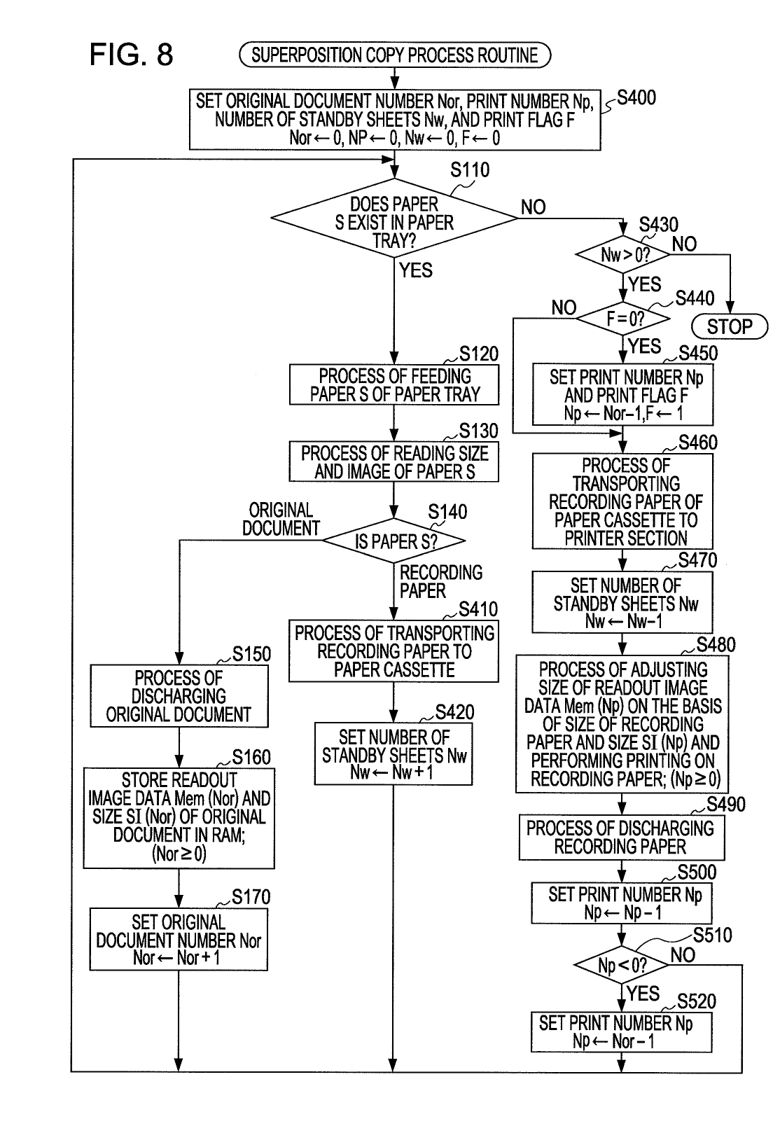

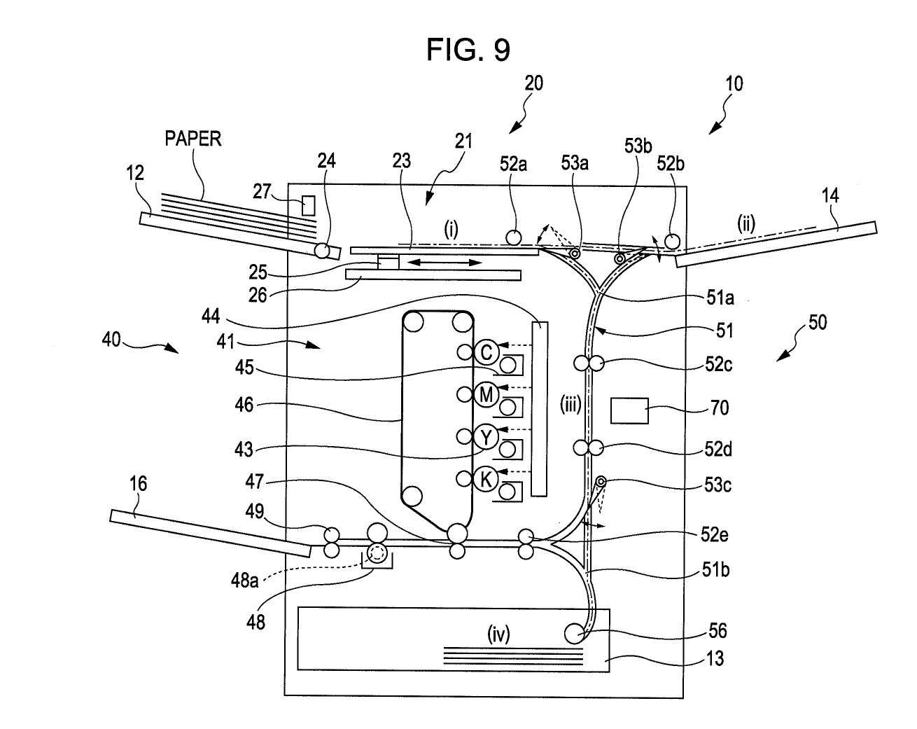

In the above-mentioned embodiment, if the paper S is the recording paper, the recording paper is transported to the printer section 40 without change, and the printing is performed thereon. However, the printing may be performed on the recording paper in a way that, first, the recording paper is transported to the paper cassette 13, it is determined whether each of all the papers S placed on the paper tray 12 is an original document or recording paper, and subsequently the recording paper is transported from the paper cassette 13 to the printer section 40. FIG. 8 shows an example of the superposition copy process routine in this case. The superposition copy process routine of FIG. 8 is the same as the superposition copy process routine of FIG. 3 except that the process of step S400 is executed instead of the process of step S100 and the processes of steps 5410 to 5520 are executed instead of the processes of steps S180 to 5230. Accordingly, the same processes are referenced by the same step numbers, and detailed description thereof will be omitted. In the superposition copy process routine of FIG. 8, first, the CPU 72 of the controller 70 respectively sets the original document number Nor and the print number Np to values of 0, similarly to the process of step S100 in the superposition copy process routine of FIG. 3, and respectively sets the print flag F and the number of standby sheets Nw, which is the number of sheets of recording paper (hereinafter referred to as standby recording paper) currently placed on the paper cassette 13 among the recording papers transported from the scanner section 20 to the paper cassette 13, to values of 0 (step S400). Then, if it is determined in step S140 that the paper S is recording paper, the transport rollers 52 and the switching members 53 are driven such that the recording paper is transported to the paper discharging tray 14 on the placed-state leading end side thereof, and the transport rollers 52 and the switching members 53 are driven such that the recording paper transported to the paper discharging tray 14 is transported onto the top of the standby recording papers in a state where the placed-state lower surface of the recording paper in the paper cassette 13 on the placed-state tailing end side is set as a lower side surface (step S410). Then, by adding a value of 1 to the number of standby sheets Nw, the number of standby sheets Nw is updated (step S420), and the routine returns to the process of step S110. FIG. 9 shows an example of the case where the recording paper is transported from the scanner section 20 to the paper cassette 13. In the drawing, the chain line and the reference signs i to iv represent the flow of the recording paper. In such a manner, the placed-state lower surface of the recording paper placed on the paper cassette 13 is set as a lower side surface thereof and the transport path 51 side is set as the placed-state leading end side thereof. By repeatedly executing the processes of steps S110 to S140, S410, and S420 in this manner, new recording papers are placed sheet by sheet on the top of the standby recording papers already placed on the paper cassette 13. If it is determined in step S110 that the paper S does not exist in the paper tray 12, it is determined that the discrimination as to whether each of all the papers S placed on the paper tray 12 is an original document or recording paper is performed, and it is determined whether or not the number of standby sheets Nw is larger than a value of 0 (step S430). Then, if the number of standby sheets Nw is larger than a value of 0, a value of the print flag F is adjusted (step S440). In contrast, if the print flag F is a value of 0, a value obtained by subtracting a value of 1 from the original document number Nor is set as the print number Np, and the print flag F is set to a value of 1 (step S450). Here, the reason, why the value obtained by subtracting a value of 1 from the original document number Nor is set as the print number Np, is that the printer section 40 performs the printing sheet by sheet in order from the recording paper placed on the paper cassette 13 later in the processes to be described later. Furthermore, if the print flag F is a value of 1 in step S440, the process of step S450 is not executed. Subsequently, the transport rollers 52 and 56 are driven such that the placed-state lower surface (the same as the readout surface) of the standby recording paper on the top of the paper cassette 13 is the same as the printed surface thereof and the placed-state leading end of the standby recording paper is the same as the leading end of the standby recording paper transported to the printer section 40 (in the embodiment, the standby recording paper is transported without change from the paper cassette 13 to the printer section 40 as shown in FIG. 2) (step S460). By subtracting a value of 1 from the number of standby sheets Nw, the number of standby sheets Nw is updated (step S470). Then, the printing and discharging process are performed on the placed-state lower surface of the recording paper transported to the printer section 40 similarly to the processes of steps S190 and S200 of the superposition copy process routine of FIG. 3 (step S480, S490). By subtracting a value of 1 from the print number Np, the print number Np is updated (step S500). Subsequently, it is determined whether or not the updated print number Np is smaller than a value of 0 (step S510). If the print number Np is equal to or larger than a value of 0, the routine directly returns to the process of step S110. In contrast, if the print number Np is smaller than a value of 0, the print number Np is set to a value obtained by subtracting a value of 1 from the original document number Nor (step S520), and the routine returns to the process of step S110. By repeatedly executing the processes of steps S110 and S430 to S520, the number of standby sheets Nw reaches a value of 0 (step S430), and then the routine is terminated. In this case, it is also possible to obtain the same advantages as the examples. Moreover, before the printing for the recording paper is started, it is determined whether each of all the papers S placed on the paper tray 12 is an original document or recording paper. Hence, it is possible to perform more promptly the discrimination between the original document and the recording paper on the all the papers S placed on the paper tray 12 as compared with the case where the completion of the printing of the previous recording paper is awaited and the reading process is performed on the next paper S.

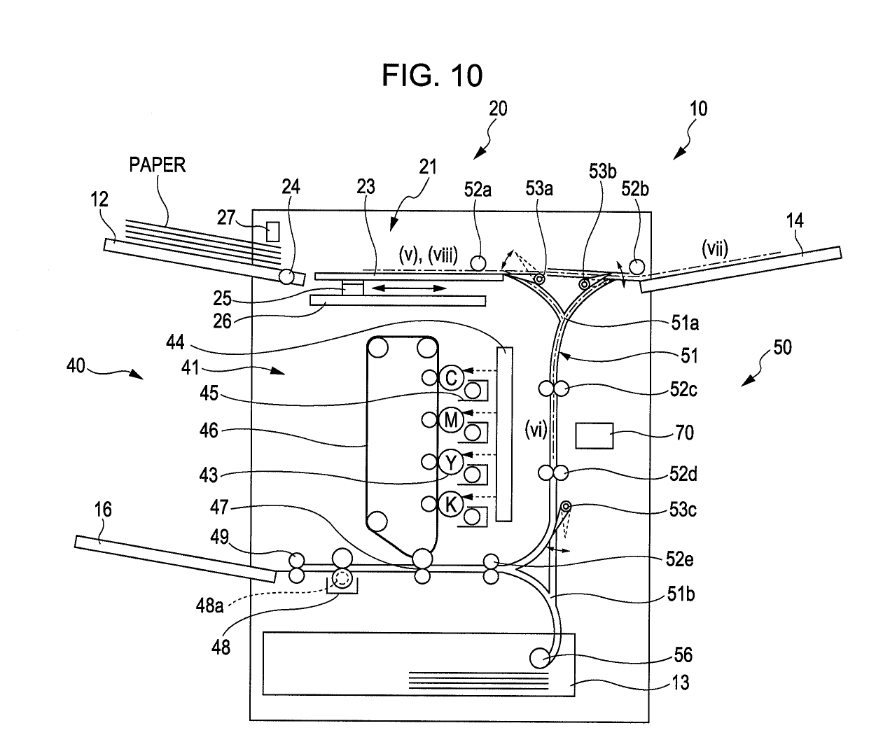

In the above-mentioned embodiment, the image, which is formed on the placed-state lower surface (the lower surface of the original document placed on the paper tray 12) of the original document, is copied on the placed-state lower surface of the recording paper. However, the image, which is formed on the placed-state upper surface of the original document, may be copied on the placed-state upper surface of the recording paper, and the images, which are formed on both surfaces of the original document, may be copied on the recording paper. In these cases, for example, instead of the process of step S120 of the superposition copy process routine of FIG. 3, the reading process may be performed on the placed-state lower surface of the paper S, a switching back process of switching back the surface of the paper S subjected to the process of reading the placed-state lower surface and transporting the paper S to the scanner section 20 may be performed, and the reading process may be performed on the placed-state upper surface of the paper S subjected to the switching back process. FIG. 10 shows an example of the transport of the paper S subjected to the switching back process. In the drawing, the chain line and the reference signs v to viii represent the flow of the paper subjected to the switching back process. In the embodiment, the switching back process is performed by: driving the transport rollers 52 and the switching members 53 so as to move the paper S from the position v to the position vi, at which the placed-state tailing end thereof is closer to the printer section 40 than the three-way junction 51a, in a state where the leading end thereof is the same as the placed-state leading end; driving the transport rollers 52 and the switching members 53 so as to move the paper S from the position vi to the position vii of the paper discharging tray 14 in a state where the leading end thereof is the same as the placed-state tailing end; and driving the transport rollers 52 and the switching members 53 so as to move the paper S from the position vii to the position viii of the scanner section 20. In such a manner, by controlling the switching transport unit 50, it is possible to read both surfaces of the paper S. In addition, when both surfaces of the paper S are read, if at least one of the first surface and the second surface of the paper S is not blank, it is determined that the paper S is the original document. Then, the paper S is discharged to the paper discharging tray 14, and the readout image and the size are stored as the image data Mem (Nor, i) (i is a value of 1 in the case of the first surface of the paper S, and a value of 2 in the case of the second surface thereof) and the size SI (Nor) in the RAM 76. In contrast, if both surfaces of the paper S are blank, it is determined that the paper S is the recording paper, and it is determined whether the printing is performed on one surface or both surfaces of the recording paper on the basis of the image data Mem (Np, i). If it is determined that one surface of the recording paper should be printed, the same processes as the processes of steps S190 and S200 of the superposition copy process routine of FIG. 3 are performed. In contrast, if it is determined that both surfaces of the recording paper should be printed, instead of the processes of steps S190 and S200, the following processes may be performed. First, the size of the image data Mem (Np, 1) is adjusted, and then the printing is performed on the placed-state lower surface of the recording paper. Subsequently, the switching back process is performed on the recording paper, of which the placed-state lower surface is printed, in the same manner as described above (in this case, the switching back process is performed by transporting the recording paper in the order of vi, vii, viii, and vi of FIG. 10). Then, the paper is discharged to the paper discharging tray 16 in a way that the printing is performed on the placed-state upper surface of the recording paper with the size of the image data Mem (Np, 2) adjusted. In such a manner, it is possible to copy an image of one surface or images of both surfaces of the original document on the recording paper.

In the above-mentioned embodiment, the scanner section 20 includes the line image sensor 25 for reading the lower surface of the paper S transported to the reading section 23. However, the scanner section 20 may further include a line image sensor, which is not shown in the drawing, for reading the upper surface of the paper S transported to the reading section 23. In this case, it is possible to read the images of the upper surface and the lower surface of the paper S transported to the reading section 23.

In the above-mentioned embodiment, the scanner section 20 includes: the line image sensor 25 that reads the lower surface (the placed-state lower surface) of the paper S transported to the reading section 23; and the transport roller 24 that transports the paper S, which is placed on the bottom of the paper tray 12, to the reading section 23, and the transport path 51 is formed to transport the paper S from the scanner section 20 to the printer section 40 without change such that the printer section 40 performs the printing on the placed-state lower surface and the placed-state leading end is the same as the leading end of the paper S transported from the scanner section 20 to the printer section 40 without change. However, the scanner section 20 may include: the line image sensor 25 that reads the upper surface (the placed-state upper surface) of the paper S transported to the reading section 23; and the transport roller 24 that transports the paper S, which is placed on the top of the paper tray 12, to the reading section 23, and the transport path 51 may be formed to transport the paper S from the scanner section 20 to the printer section 40 without change such that the printer section 40 performs the printing on the placed-state upper surface and the placed-state leading end is the same as the leading end of the paper S transported from the scanner section 20 to the printer section 40 without change. In this case, when instructing the copying of the images of the original documents on the recording papers in a state where the original documents, of which the images are formed on the placed-state upper surfaces, and the recording papers are placed in this order from the top in the paper tray 12, it is possible to copy the images of the placed-state upper surfaces of the original documents on the placed-state upper surfaces of the recording papers.

In the above-mentioned embodiment, the case where the original documents and the recording papers are placed in this order from the bottom in the paper tray 12, that is, the case where the paper S is the recording paper and the image data stored in the RAM 76 exists was described. However, when the recording papers, the original documents, and the recording papers are placed in this order, in the case of the first recording paper (in the case where there is no image data stored in the RAM 76), the transport rollers 52 and the switching members 53 may be driven so as to discharge the recording paper to the paper discharging tray 14 without change.

In the above-mentioned embodiment, the three-way junctions 51a and 51b are formed to determine the direction of transporting the paper S in the transport path 51. However, a switching member, which is not shown in the drawing, for switching the transport destination may be provided.

In the above-mentioned embodiment, the printer section 40 was described which was a full-color-electrophotographic type. However, it may be possible to use an ink-jet-type full-color printer section, a thermal-transfer-type full-color printer section, a dot-impact-type color printer section, and monochrome printer sections of these types.

In the above-mentioned embodiment, the multi-function peripheral 10 was described as a copying apparatus. However, it may be a form of a control method of the copying apparatus, and may be a form of a program for executing the steps of the control method of the copying apparatus.

What is claimed is:

1. A copying apparatus for copying an image of an original document on a recording paper, the copying apparatus comprising:
a reading section that transports paper, which is an original document or recording paper and is placed on a paper placing section capable of containing the paper, and reads a size and an image of the paper;
a printing section that performs printing on the paper and discharges the paper;
a switching transport section that switches transporting of the paper, of which the image is read by the reading section, to the printing section side and discharging of the paper;
a storage section that stores data;
a determination section that determines whether the paper, which is read by the reading section, is an original document or recording paper; and
a control section that,
when the determination section determines that the read paper is the original document,
controls the switching transport section to discharge the original document, and
stores the size and the image of the original document, which is read by the reading process, in the storage section, and
when the determination section determines that the read paper is the recording paper,
controls the switching transport section to transport the recording paper to the printing section, and
controls the printing section to perform printing on the recording paper and discharge the recording paper on the basis of adjustment between the size of the recording paper and the size of the stored image based on the original document size stored in the storage section.

2. The copying apparatus according to claim 1, wherein the switching transport section is operable to transport the paper to the printing section so that the printing section performs printing on the same surface of the paper of which the image is read by the reading section.

3. The copying apparatus according to claim 1, wherein the switching transport section is operable to transport the paper to the printing section so that a leading end of the paper is the same when the paper, which is placed on the paper placing section, is transported by the reading section and when the paper is transported to the printing section.

4. The copying apparatus according to claim 1,
wherein the switching transport section is operable to transport the paper, on which the image reading is performed by the reading section, to a second paper placing section on the printing section side, and is operable to transport the paper on the second paper placing section to the printing section, and
wherein when it is determined that the read paper is the recording paper, the control section controls the switching transport section to transport the recording paper to the second paper placing section, and controls the switching transport section to transport the recording paper, which is transported to the second paper placing section, to the printing section.

5. The copying apparatus according to claim 4, wherein after it is determined whether each of all the papers placed on the paper placing section is an original document or recording paper, the control section controls the switching transport section to transport the recording paper, which is transported to the second paper placing section, to the printing section.

6. A control method of a copying apparatus including: a reading section that transports paper, which is an original document or recording paper and is placed on a paper placing section capable of containing the paper, and reads a size and an image of the paper; a printing section that performs printing on the paper and discharges the paper; a switching transport section that switches transporting of the paper, of which the image is read by the reading section, to the printing section side and discharging of the paper; a storage section that stores data; and a determination section that determines whether the paper, which is read by the reading section, is an original document or recording paper, the control method comprising:
when the determination section determines that the read paper is an original document,
controlling the switching transport section to discharge the original document; and
storing the size and the image of the original document, which is read by the reading process, in the storage section; and
when the determination section determines that the read paper is recording paper,
controlling the switching transport section to transport the recording paper to the printing section; and
controlling the printing section to perform printing on the recording paper and discharge the recording paper on the basis of adjustment between the size of the recording paper and the size of the stored image based on the original document size stored in the storage section.

7. A program for causing one or more computers to execute the control method of the copying apparatus according to claim 1.
